(19) United States
(12) Patent Application Publication
(10) Pub. No.: US 2010/0323180 A1
(43) Pub. Date: Dec. 23, 2010

(54) Foldable Soft Mat

(76) Inventor: Willy Chen, Taipei County (TW)

Correspondence Address: SHOU - HSIN YIN, P.O. BOX 90-3 Taipei, TAIPEI City, 10699, TW

(21) Appl. No.: 12/489,524

(22) Filed: Jun. 23, 2009

(51) Int. Cl. B32B 3/26

(52) U.S. Cl. 428/221

(57) ABSTRACT

A foldable soft mat used for outdoors, swimming pools or beaches is disclosed. The mat includes a plurality of soft rods. The rods are parellelly strung to form a mat body by two textile belts. A marginal rod of the mat body is provided with two fasteners for terminating two ends of the textile belt and a handle connected between the two fasteners. A folding spacer is provided between predetermined two adjacent rods for forming a folding space. Thus the mat body can be easily folded and carried.

### BACKGROUND OF THE INVENTION

1. Technical Field

The invention generally relates to mats, particularly to foldable and portable mats for outdoor use.

2. Related Art

Mats for outdoor activities or aquatic sports usually feature light weight and comfort. Further, mats will be better if they have compact volume and are easy to be carried. Most of conventional mats are made of texture or plastic. Though they are light and foldable, their comfortivity is not good enough because their thickness is deficient. Some mats in markets are made of nature materials such as tule or bamboo. Their comfortivity is better and they can be rolled up to be carried, but external sands and dusts tend to infiltrate woven structure thereof. The tule or bamboo mats are difficult to be cleaned out, and their durability is not good enough.

A kind of block typed mat made of foam rubber also can be seen in the markets. Their comfortivity and durability is very great, but their costs are very expensive because they must be manufactured by large scale machines. More importantly, this kind of mat can not be used for outdoors or beaches.

### SUMMARY OF THE INVENTION

A primary object of the invention is to provide a soft mat which is foldable, portable, light and waterproof, and can be used for outdoors, swimming pools and beaches.

A secondary object of the invention is to provide a soft mat which can be manufactured by small scale machines. Also, the size of the mat can be easily changed in manufacture process.

To accomplish the above objects, the invention includes a plurality of soft rods. The rods are parellelly strung to form a mat body by a textile belt in a U shape. A marginal rod of the mat body is provided with two fasteners for terminating two ends of the textile belt and a handle connected between the two fasteners. A folding spacer is provided between predetermined two adjacent rods for forming a folding space. The folding spacer is a textile strap striding between the parallel textile belts.

The soft mat of the invention is light, comfort and portable. Also, the mat is suitable for outdoors, swimming pools and beaches. Besides, the size of the mat can be changed by adjusting quantity and/or length of the rods. Thus it is very economical for manufactures.

### BRIEF DESCRIPTION OF THE DRAWINGS

FIG. 1 is a perspective view of the invention in an expanded status;

FIG. 2 shows how the fasteners and textile belt bind together;

FIG. 3 shows a detailed view of the fastener and textile belt;

FIG. 4 shows a detailed view of the folding spacer;

FIG. 5 is a sectional view along line A-A′ in FIG. 1; and

FIG. 6 is a perspective view of the invention in a folded status.

### DETAILED DESCRIPTION OF THE INVENTION

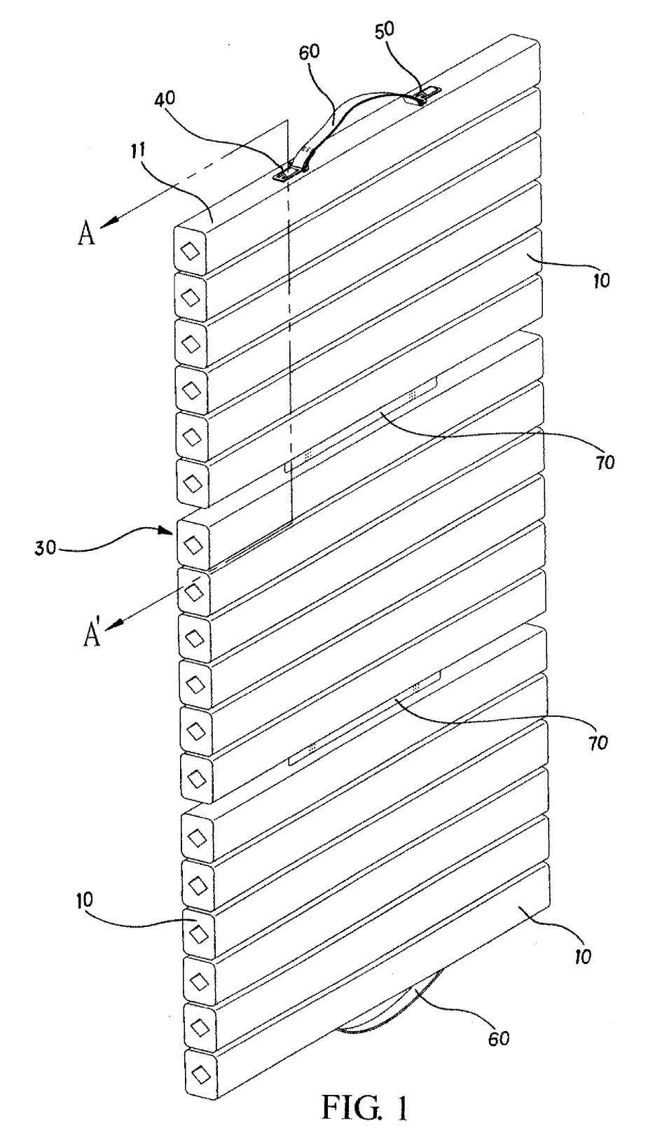

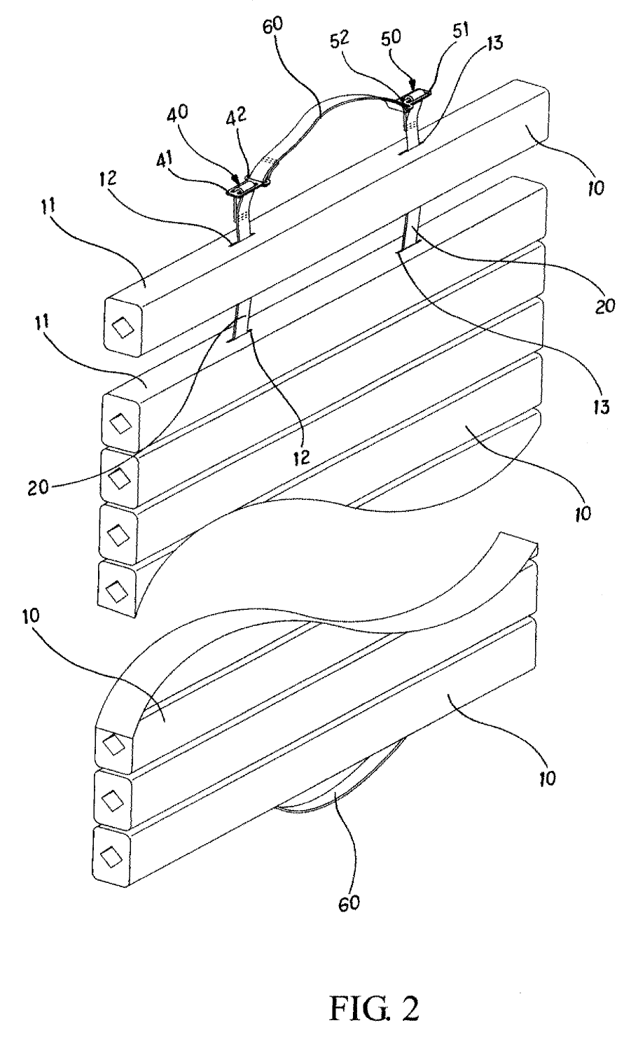

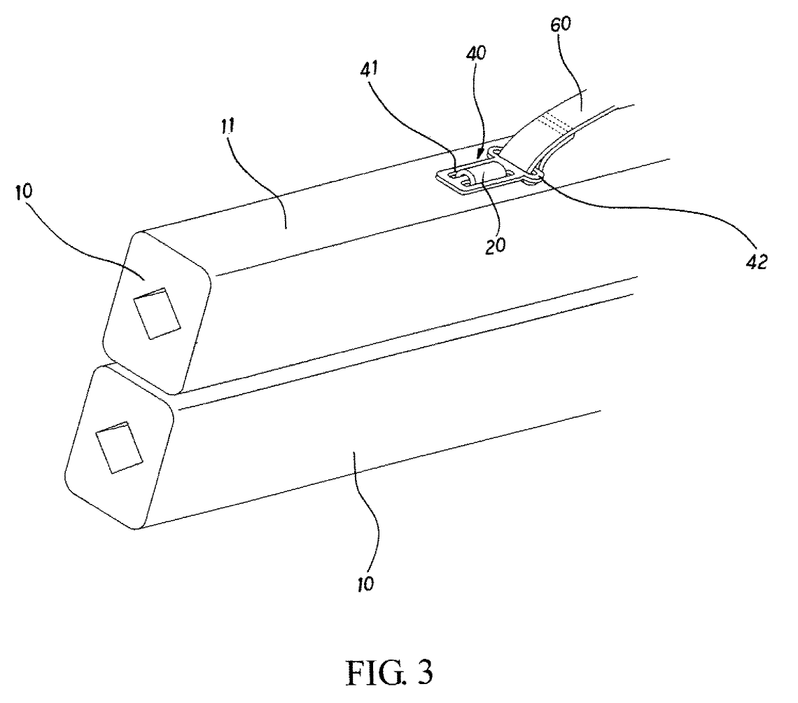

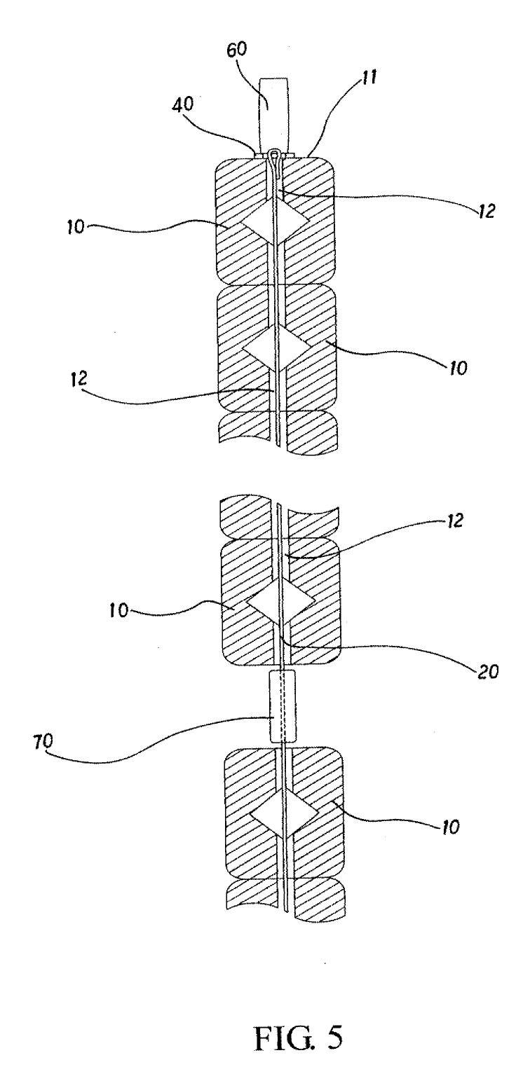

Referring to FIGS. 1 to 3, the invention provides a foldable soft mat for lying or sitting. The mat includes a plurality of soft rods 10 made of material with zero or low hygroscopicity, such as polyethylene (PE), polyurethane (PU), polyvinyl chloride (PVC), ethylene vinyl acetate (EVA) or polystyrene (PS). The rods 10 can be solid or hollow. The rods 10 are parallelly arranged and strung by two parallel textile belts 20, 22 to form a mat body 30 with a predetermined length. Each of the rods 10 is provided with two through holes 12, 13. The textile belts 20, 22 separately penetrate the through holes 12, 13 of each rod 10. (further referring to FIG. 5) Both lateral sides 11 of each rod 10 are in contact with that of another adjacent rod 10. An exposed lateral side 11 of each of two marginal rods 10 is provided with two fasteners 40, 50 for terminating the textile belts 20, 22. A handle 60 is arranged between the two fasteners 40, 50. The fasteners 40, 50 are made of plastic. Each of the fasteners 40, 50 is composed of a hook portion 41, 51 and a ring portion 42, 52 beside the hook portion 41, 51. The hook portion 41, 51 is used for being strung by one of the textile belts 20, 22. The ring portion 42, 52 is used for being fixed by the handle 60.

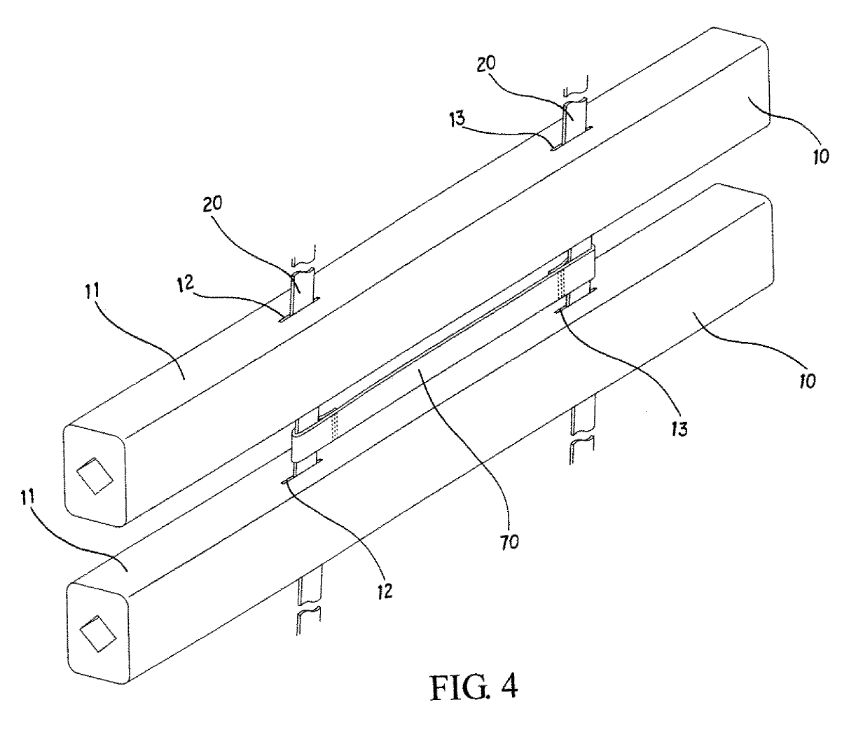

Referring to FIGS. 4 and 5, a folding spacer 70 is provided between two predetermined adjacent rods 30. The folding spacer 70 is a strap made of texture and strides on the two textile belt 20, 22 between two adjacent rods 10. The folding spacer 70 forms a folding space S of the mat body 30 for being folded.

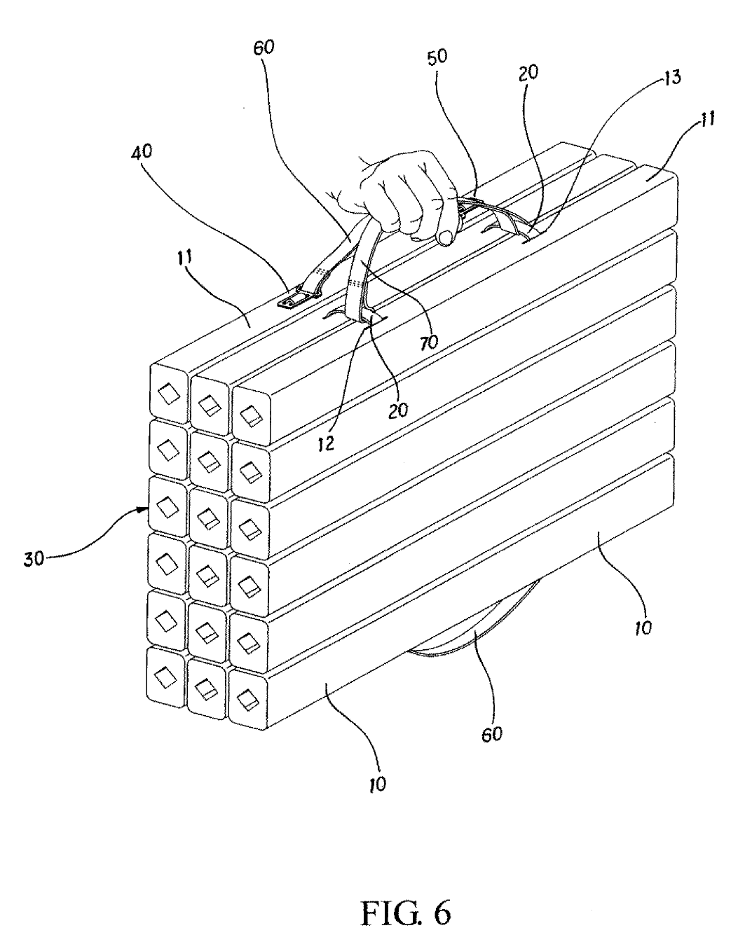

Accordingly, the mat body 30 can be flatly unbent for being lain or sit by a user. The mat body 30 is very light and comfortable because the rods 10 are made of soft material. When a user wants to carry the mat body 30, he/she can simply fold the mat body 30 at the position the folding spacer 70 locates as shown in FIG. 6. Then the user can hold the handle 60 to carry the mat body 30 with reduced volume.

It will be appreciated by persons skilled in the art that the above embodiment has been described by way of example only and not in any limitative sense, and that various alterations and modifications are possible without departure from the scope of the invention as defined by the appended claims.

What is claimed is:

1. A foldable mat comprising:
a plurality of soft rods parallelly arranged in a row and strung by two textile belts, wherein each of the soft rods is provided with two through holes on lateral sides thereof, the textile belts separately penetrate the through holes for stringing the soft rods to form a mat body;
two fasteners disposed on each of the soft rods at two corresponding margins of the mat body, separately terminating the textile belts;
two handles separately fixed between the two fasteners on one of the soft rods; and
at least one folding spacer, being a strap with a predetermined width, disposed between two adjacent soft rods, and striding on the two textile belts for forming a folding space.

2. The foldable mat of claim 1, wherein the soft rods are made of material with zero or low hygroscopicity.

3. The foldable mat of claim 1, wherein the soft rods are axially hollow.

4. The foldable mat of claim 1, wherein the soft rods are made of polyethylene (PE), polyurethane (PU), polyvinyl chloride (PVC), ethylene vinyl acetate (EVA) or polystyrene (PS).

5. The foldable mat of claim 3, wherein the soft rods are made of polyethylene (PE), polyurethane (PU), polyvinyl chloride (PVC), ethylene vinyl acetate (EVA) or polystyrene (PS).

6. The foldable mat of claim 1, wherein each of the fasteners is composed of a hook portion for being strung by one of the textile belts and a ring portion beside the hook portion for being fixed by the handle.
